(19) United States
(12) Patent Application Publication
(10) Pub. No.: US 2012/0111798 A1
(43) Pub. Date: May 10, 2012

(54) Process and Means for Treatment of an Oil Spill

(76) Inventor: Atle Mundheim Ylikangas, Omastrand (NO)

(21) Appl. No.: 13/255,050

(22) PCT Filed: Mar. 5, 2010
(86) PCT No.: PCT/NO2010/000087

§ 371 Date: Jan. 16, 2012

(30) Foreign Application Priority Data
Mar. 6, 2009 (NO) 20091029

(51) Int. Cl. E02B 15/04; C02F 1/28; C02F 1/40

(52) U.S. Cl. 210/691; 210/170.01

(57) ABSTRACT

A method and a device are described to be able to neutralise the damages from an oil spill at sea or on a lake by rapid addition of an absorbent where this can also be carried out in very poor weather, and also a method to remove oil spills as particulate absorbed material, store this at sea and thereafter transport this ashore, and also process the spill further ashore. An application of the method is described for oil protection emergencies and in oil spills at sea or in lakes.

The present invention relates to a method for treatment of oil spills at sea or on land, as can be seen in the introduction of the subsequent independent claim 1.

The invention also relates to-a device for transportation of an absorption agent as given in the introduction of claim 15.

Furthermore, the invention relates to the method given in the claims 12 and 13.

In more detail, one aims to provide new application and collection methods and equipment to limit the damages from an oil spill, in that one seeks to absorb, retain and collect the oil pollution and lead it ashore, store and treat it in a safe way. One also wants to make the treatment independent of the weather conditions, and to simplify the treatment of the absorbed oil spill when this is collected and brought ashore.

Oil spills at sea or on lakes happen unintentionally or as a consequence of accidents, and always lead to pollution of sea shores with the marine life and birds suffering and being injured.

The methods the agents according to the invention can not be used by known and applied technology in oil protection emergencies.

### Known Methods That are in use Today

Today, oil protection is mainly based on the use of booms handled by ships to catch oil spills at sea. Skimmers are used to skim the oil layer, together with some water, onboard a ship. Thereafter, the water is separated from the oil which is then processed further.

As an exception, absorption agents are used at sea/on lakes for large oil spills. Dispersion agents that are spread out from boats are also used, whereupon the oil is collected and sinks to the bottom to be further broken down.

When an oil spill hits the shoreline, one tries to prevent this by putting out booms. If the weather is poor, or when one does not have time to mobilise, the oil will hit the shoreline and cause much damage and require a resource demanding cleaning operation.

Such cleaning operation requires removal of viscous oil, subsequent use of absorbents and washing agents, and often use of biologically decomposition-promoting materials.

It is also known that peat moss from Sphagnum, preferably not very decomposed, collected from the upper layers of the peat moss and not from the live plant, has a large absorption capacity for oil and is water repellent when in a dried condition (preferably dried above 100° C.). The product is commercially available and is used to absorb oil spills on land and on water. 1 m³ dried Sphagnum with a moisture level at 10-15% weighs about 125-150 kg and can absorb up to 1 m³ oil.

It is known that the Sphagnum absorbent closes the pores when it is saturated with oil and that the pores are not opened until the hydrocarbons are broken down to CO₂ and water. This process occurs naturally in that hummus acids and enzymes that are naturally present in the product in soils/sand/air or the sea come into contact with naturally occurring bacteria. Furthermore, it is known from documentation accepted by the Environmental Protection Agency (EPA) in the USA that the product satisfies the American requirements for leakage for deposition on a landfill site after use as an oil absorbent. A pressure of about 4 bar is required on the cell wall of the Sphagnum before any leakage will occur.

Consequently, a correctly dried peat moss of Sphagnum can absorb and encapsulate oil so that it is not naturally available to the surroundings. The Sphagnum absorbent is also an ideal host for biodegradation.

It is also known that dried peat moss is applied to oil spills by using air through so-called “blowers”. Air is driven at great speed through a mouthpiece and the peat moss is fed into the air stream before the mouth piece. It is known that the method throws the peat moss only a few meters and the dust cloud that arises is formidable. Therefore, the method of blowing the absorption agent over an oil spill is rarely used for this product.

Such blowers can be placed on the windward side of the pollution so that the dust cloud can, for example, be blown out over the ocean, and with the wind, settle on thin oil films.

The limitation of today's methods is that they can not be applied in poor weather. Wind and the height of waves place strict limitations on when boats can operate booms and skimmers. A wave height of three meters is the maximum tolerable for most booms. In the, shoreline zone it is not possible to set out booms when the weather is poor, and the oil pollution will therefore have free access, and do much damage to, the shoreline and thereafter be collected with the use of much resources.

When incidents occur it often takes a long time to mobilise all the equipment that is used with today's solutions for oil collecting, and the operation from the start of the collecting to the oil spill being collected is very time consuming even when the weather is fine. In many cases, when the weather is poor, one must also wait days before one can start the operations. This will increase the extent of the damage to bird life, and there is a great risk that the oil spill will reach the shoreline. The spill is potentially damaging until it is completely gathered up.

In known and traditional skimming from booms, 90% water and 10% oil is the average content of the mixture that is pumped onboard the ships. This means that ships must shuttle back and forth to deliver the oil/water mixture ashore. Boats, equipment and personnel are exposed to the oil. The operation with slippery oil onboard, which shall be brought onboard the ships, is a safety risk for the crew even when the sea is calm.

In traditional dispersion of a light absorption agent over an oil spill at sea, it is restricting that the length one can throw with today's distributors is only a couple of meters, and they do not function in strong wind. Personnel and ships are exposed to dust clouds which results in the blowing of absorbents not being used today.

Therefore, it is an aim of the invention to provide a new and improved method and process and procedure which completely or partially can eliminate the above mentioned disadvantages in today's treatment of oil spills.

In more detail, it is an aim to provide new and improved procedures to bring a light absorption agent in contact with an oil spill at sea or on lakes which immediately can reduce the damage from the pollution.

Furthermore, it is an aim to provide an improved method for treatment and transport ashore of the collected oil pollution.

Furthermore, it is an aim to provide a simplified treatment of the collected oil pollution when this is brought ashore.

The present invention relates to supplying and distributing dried peat moss of the

Sphagnum variety with the help of different methods adjusted to different situations and weather conditions, so that the moss is effectively and quickly spread over the oil pollution, absorbs and isolates the oil from the water phase and thereby also isolates it from being exposed to the marine environment, seabirds and shoreline.

The method according to the invention is characterised in that the peat moss is compressed and wrapped in a package which each comprises a release mechanism that can release the peat moss from the wrapping so that it is spread freely into or over the oil pollution, with the oil being collected and further treated. Preferred embodiments are given in the claims 2-12.

According to the invention, the remainder that is formed from peat moss with residual oil attached is used for energy purposes in that it is burnt. The method is well suited to use in oil protection operations and in oil spills at sea or on lakes.

The device according to the invention is characterised in that the absorption agent is compressed and stored in a packaging (a bag) which comprises means to deform the packaging for subsequent release of the absorption agent from the packaging.

The deforming agent is preferably an explosive charge associated with the packaging, and set up to make the packaging burst open to release the absorption agent. It also comprises means for time setting and remote control of a release mechanism associated with the deformation agent.

According to the present invention, a method and equipment are thereby provided that are well suited to quickly and effectively distributing an absorption agent of dried peat moss from the dead part of the Sphagnum plant over an oil pollution at sea or on a lake, regardless of the weather conditions, whereby the extent of damage from the pollution is immediately drastically reduced.

With the method for collection of absorbed oil pollution in the supplied absorbent, one obtains considerable reduction of operational risks, one can operate faster and under considerably poor weather conditions.

Furthermore, equipment and a method are provided for temporary storage in water/subsequent transportation ashore of the pollution, alternatively a simplified separation of the oil absorption agent/water onboard a ship directly is provided so that the amount of water that is transported ashore can be reduced.

With the invention, an absorption agent of dried, hydrophobic Sphagnum peat moss collected from the top layer of the peat moss where the peat is only partially degraded, is placed on an oil spill that floats at sea or on a lake so that it absorbs the oil into its pores, whereupon the pores are closed by a natural mechanism and retain the oil and isolate it from the water in the peat moss.

According to the invention, dried peat moss from lightly degraded Sphagnum is placed onto an oil slick or oil spill in that it is wrapped up in large balls with a suitable packaging. Means are placed in the packaging to deform the packaging, either mechanically or by gas expansion, where a release mechanism ensures that this takes place at a predetermined point in time and where this can also occur with such a force that the peat moss is emptied from the packaging and spread out over the oil spill.

In more detail, enwrapped dried peat moss, with said release mechanism and the device to deform, burst open or rip open the packaging over a polluted area is released from the air by a plane or a helicopter. Thus, the moss is dropped over the pollution with the release of the packaging taking place automatically when the moss balls are at a given height above sea level, or on hitting the surface of the water or manually triggered by a signal from a remote control unit, for example, by personnel onboard the airplane or on board an assisting vessel.

Alternatively, the enwrapped and dried peat moss can be brought to a polluted area by a boat and be towed into the pollution by booms with a number of peat moss balls continuously arranged in each link, whereupon activation of the release mechanism and deformation of the packaging is triggered by a controlled signal from the remote control unit onboard the vessel.

According to the invention the absorbent and the oil pollution can be gathered from the surface of the sea with the help of a trawl bag, in more detail, in that a partly submersible trawl, for example, a smooth cloth is pulled through the area of the sea covered by the peat moss with the absorbed pollution, so that this is led into a bag of a fine mesh cloth at the end of the trawl with a mesh sufficiently small to collect the peat moss fibres with the absorbed oil.

When the rear trawl bag is sufficiently filled with oil-containing absorbent (the Sphagnum moss), it can be drawn together and a floating marking buoy will be fastened to the trawl bag. Thereafter the trawl bag will be released from the main trawl so that it floats freely in the sea with the gathered pollutant.

Subsequently, new trawl bags can be used, be filled and stored in the water with marking buoys to be brought together to be hoisted onboard a ship or towed ashore.

The absorbed oil pollution can also be collected via booms, skimmers and pumps for immediate separation from water in mechanical appliances onboard ships, and/or stored further in bags that float in the sea and are brought ashore later for further processing.

Further on in the process, for example, ashore, or onboard a ship, the peat, moss can be processed in two steps:

Step 1) Water is forced out of the peat moss with the absorbed oil pollution with the help of a gently applied pressure from a screw press or the like, where this applied pressure does not exceed the bursting pressure for the cells with absorbed oil in the peat moss.

Step 2) where the oil is forced out and recovered by subjecting the peat moss with absorbed oil to a further pressure that is greater than the pressure required to burst the cell wall of the peat moss where the oil is absorbed. The cell wall is then subjected to a pressure which results in the internal pressure in the cell exceeding the level at which the wall bursts so that the oil is released and can be recovered. This pressure is normally around 4 bar.

According to the invention, peat moss treated in this way, where the oil is forced out and where hydrocarbon residues attached to the peat moss can be found, is applied in energy production. In particular, in that the mass is subjected to a combustion.

According to a preferred method for neutralising the damages from an unintended oil spill at sea or on a lake, dried, hydrophobic and oleophilic peat moss, preferably from the dead and lightly degraded part of the plant family Sphagnum, is added to an oil slick in that the peat moss is wrapped up in balls and is brought to the area that is polluted by a transport plane or a helicopter, whereupon the balls are dropped, and in which an optional release mechanism can be found, which deforms the packaging, either in the air or at a certain height or as the balls hit the water surface/oil surface.

With the application, the peat moss absorbs the oil, encapsulates it into the oil-absorbing pores and makes sure that it can not damage the marine environment and birds, and pollute the seashore.

The chosen release mechanism shall be loaded into the balls according to weather conditions and the extent of the spill.

If the weather conditions and time permit, the peat moss can also be applied in that it is brought onboard a ship with fire cannons or other water transport systems with a long throw distance where the peat moss is supplied a stream of water via an ejector and is sprayed over the surface of an area of water that is covered with oil.

According to a preferred method for collecting an oil spill absorbed in moss, a partially submersible trawl is used which collects the spill in a bag that can be temporarily deposited in water without any oil leaks of any consequence as the peat moss has encapsulated the oil.

Alternatively, the oil spill absorbed in peat moss can be collected with skimmers, booms or other known equipment, where upon coarse separation of water can take place onboard a ship, whereby oil absorbed in moss can be stored in the sea in suitable fine mesh bags or cloth bags, whereupon marking buoys are fastened so that these can later be collected to be loaded onto a ship or towed ashore.

### Advantages With the Present New Method

The present invention distinguishes itself from existing solutions in that the absorption agent can be brought to the polluted area by a plane or a helicopter and neutralise the oil spill much faster, and approximately independently of the weather conditions. Transport planes or helicopters are used and can operate with a large reach in nearly all weather conditions in a short time.

The release mechanism makes it possible to choose the height at which the blowing up of the packaging for the release of the mass, and can also be varied with respect to how high above the spill the packaging shall be blown up, so that the light peat moss gets the proper distribution independent of the strength of the wind and the height of the waves.

Oil spills are rendered harmless immediately upon the addition of the absorbent in that the absorbent encapsulates the oil in its cells so that this is not available to the marine environment or birds, and also that it does not cling onto ships, equipment or the seashore.

Furthermore, the addition can take place using alternative methods if the situation requires this, such as, for example, in that the same enwrapped balls with peat moss can, if the weather conditions allow, be towed out to the spill in booms behind a ship, whereupon these are towed into the oil pollution, whereupon the release mechanism for blowing up the packaging/spreading of the peat moss is activated.

Furthermore, a method is provided for collection of the oil spill which means that one collects organic solid material in the form of peat moss instead of liquid oil, and that this takes place in a trawl where the bag collects oil absorbed in peat moss. The collected oil spill can easily be separated mechanically onboard a ship. With today's methods, 90% water and 10% oil is collected and the ships must run in shuttle traffic to the shore for unloading and separation.

The present invention can, with simple screw presses, significantly reduce the water content, or temporarily store separated pollution in bags in a lake or at sea, as leakage of absorbed oil in moss does not occur, and also that the product can stay afloat for up to three weeks or more.

The accumulated pollution can be collected in bags that can be brought ashore when the weather conditions or practical considerations allow this. Furthermore, the oil polluted mass can be further processed ashore in a simple screw press in that water is forced out at low pressure and oil is pressed out of the cells in the peat moss at an applied pressure above 4 bar, so that relatively clean oil is recovered.

The absorbent, the peat moss, with the residual oil after the pressing after an oil spill, can be used as an energy source in that it can be combusted.

With the application of peat moss, preferably the dead part of the plant family Sphagnum, dried and made oleophilic and hydrophobic by known technology, is enwrapped in large, compressed balls with a packaging that can be blown up, with a device which mechanically, explosively or with the help of a release of gas is in a position to blow up the packaging and at the same time substantially spread out the peat moss.

The release mechanism for the blowing up/spreading can be activated at a chosen height at the drop of the balls from a plane or a helicopter, or when they hit the surface of the oil/sea/lake, or by manual activation in that the balls are towed in booms into the pollution with the help of ships.

The known ability of peat moss to absorb of quality as described separates the oil spill from the environment, and the spill is transformed from a liquid phase to a solid phase form, and application of a fine mesh trawl with a mesh fine enough to catch the moss fibres can be used for the collecting.

One can also use known bilging techniques, skimmers and pumping techniques to bring the material onboard a ship, where with simple known techniques, water can be separated as it is now in a solid form. The separated material can then be put into storage bags that are deposited in the sea for later transport ashore/collection onboard a ship.

One application of polluted mass is provided in that water is forced out at a lower pressure than the bursting pressure of 4 bar for the closed pores which have absorbed oil, whereupon oil can be recovered by pressing further in a step two at a higher pressure than the pores in the peat moss can withstand, so that a relatively concentrated oil is forced out.

One application for energy purposes for the pressed, used absorbent will be combustion of the peat moss with the residual hydrocarbons as this will have a very high calorific value.

The present invention is characterised in that peat moss made suitable for absorption of oil is made into enwrapped balls that contain a release mechanism which bursts open the balls and spreads the peat moss over an oil spill at sea or on a lake, whereupon the oil spill, after absorption in the peat moss, is isolated, made into particles and does not expose the environment to the known harmful effects and can be collected, be transported and processed as particulate material instead of as a fluid.

The device according to the invention shall now be explained further with reference to the enclosed figures, in which:

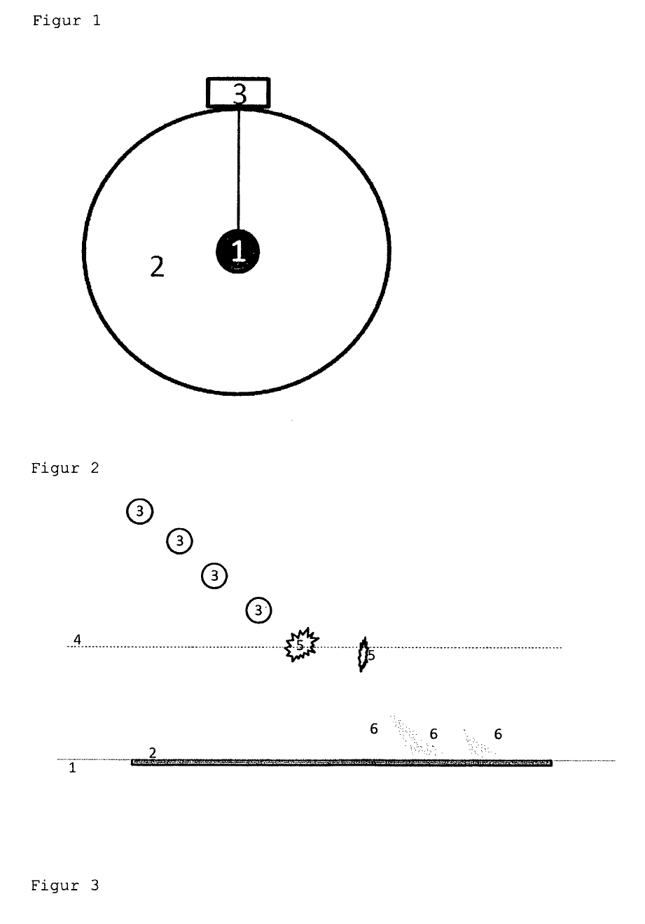

FIG. 1 shows packaged peat moss with a release mechanism, and a mechanism for bursting open the packaging
(1) shows the packaging
(2) shows the release mechanism which is triggered either on impact with the sea surface or at a predetermined height above the sea
(3) shows the mechanical blow up mechanism, gas or explosive charge mechanism.

### EXAMPLE 1

A ball of 5 m³ double-compressed peat moss, as described above, is dropped over an oil spill. Taking into account the wind conditions, the explosive charge is triggered at a height that ensures an optimal spread of the peat moss according to the thickness of the oil layer.

With an optimal spreading over the oil layer, the peat moss ball will be able to absorb 10 000 litres of oil. If the oil layer is 1 cm thick, 5 m³ double-compressed peat moss, with a theoretical optimal spreading is able to render an oil slick of 1 000 m³ harmless, and a spill of 100 000 litres of oil can be neutralised with 10 balls of a total of 50 m³ double-compressed peat moss. 1 m³ double-compressed dried moss as described above, weighs 150 kg, and a military transport plane with a device for dropping will be able to transport 125 m³ double-compressed moss with no difficulty. This means it will be possible with one single trip to drop enough moss to absorb 250 000 litres of oil, and if the oil layer was 1 cm thick and optimal spreading was achieved, one drop will be able to cover an oil slick of 50 000m³.

### FIG. 2

Shows an example where the moss ball is dropped from an aeroplane/helicopter for spreading of packaged peat moss with the help of the device as is shown in FIG. 1, where the release mechanism is set to a given height above the sea where the packaging is blown up/deformed and makes the peat moss spread out over an oil slick through the air;
(1) Ocean surface.
(2) Oil slick on the ocean surface.
(3) Illustrates packaged peat moss with a blow up/deformation device and the release mechanism as shown in FIG. 1.
(4) Dotted line illustrates the height above the sea where the release mechanism is set to activate the blowing up/deforming of the packaging.
(5) Shows the blowing up/deforming of the packaging.
(6) Shows peat moss that is spread through the air and lands on an oil slick under calm wind conditions.

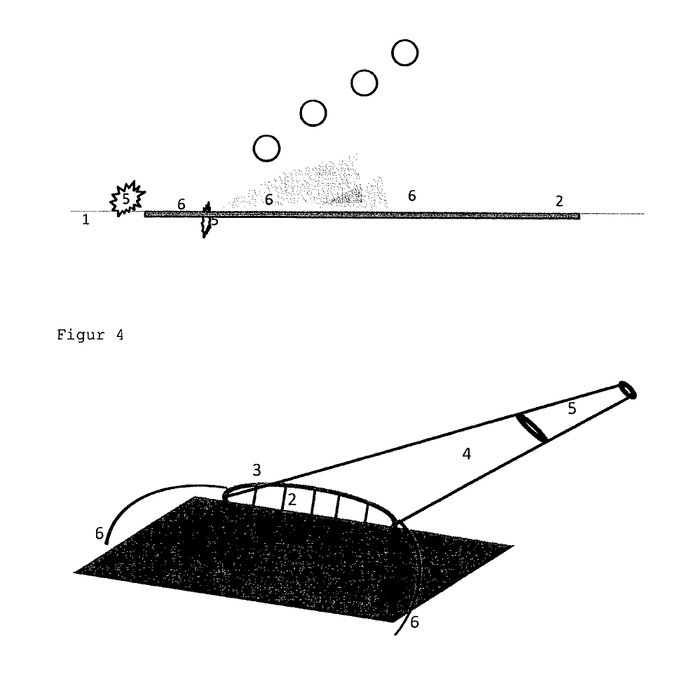

### FIG. 3

Shows a drop from a plane/helicopter in a strong wind, storm or hurricane for spreading of packaged peat moss with the help of the device shown in FIG. 1 where the release mechanism is set to activate on impact with the surface of the ocean where the packaging is blown apart/deformed and leads to peat moss spreading directly over the oil slick and with the help of wave movements and through the air with wind as power for the distribution;
(1) Ocean surface
(2) Oils slick on the ocean surface
(3) Illustrates packaged peat moss with the blowing apart/deformation device and the release mechanism as shown in FIG. 1.
(4) Shows the wind direction.
(5) Illustrates the blowing apart/deformation of the packaging on direct impact with the ocean surface where the release mechanism is set to activate the blowing apart/deformation of the packaging.
(6) Shows peat moss which is spread over an oil slick through the air with the help of the wind, waves or direct placement.

### FIG. 4

Illustrates the partially submersed trawl described in the invention for collection of peat moss with absorbed oil spill:
(1) Shows an oil spill absorbed in peat moss that floats in the sea or on a lake.
(2) Illustrates a device for the partially submersed solution comprising a floating element that holds the lower part of the trawl below the ocean surface sufficient for the floating mass to be caught in the trawl, at the same time as the upper part of the trawl is held above water so that the pollution is caught in high waves.
(3) Illustrates the trawl opening where floating elements and reinforcements for fastening of the conformed cloth of the trawl are secured.
(4) Shows a funnel of light, smooth material which allows the absorbed pollution to glide towards the trawl bag.
(5) Shows a detachable trawl bag which can be drawn together and replaced when full. This has an opening in the cloth that lets water through but retains the peat moss fibres with absorbed oil.
(6) Indicates fastening points for a tow line for a ship on each side of the boom that is fastened to the trawl opening.

### EXAMPLE 2

A trawl of a width of 100 m is swept through an absorbed oil slick by two boats at a speed of 4 knots. That means 740800 m³ is swept per hour. If the oil store is as in example 1, this means that 250 000 litres oil absorbed in moss is scooped up per hour/trawl.

### Test 1:

1 cm³ crude oil was distributed in a 1×1 m tank which was partially filled with water, and 10 l moss was evenly distributed over the polluting oil by sprinkling the moss over the tank. The tank was placed on a tilting table to simulate small wave movements.

It was observed that the oil was absorbed in the peat moss within one minute, and one could put one's hand into the water/pollution without oil sticking to the hand. Attempts were made to put bird feathers into the mixture and use them to stir the mixture round for a minute. No oil stuck to the feathers. Attempts were made to put parts of the oil absorbed moss on stones and feather sand. No dewatering or transfer of oil to the sand/stone was observed. Attempts were made to remove oil absorbed in the moss from the surface by sweeping a bag with a trawl cloth with a pore opening of 1 mm above the surface to simulate a trawl bag. Approximately 100% of the polluted material was removed and no oil film could be observed on the surface of the water afterwards.

### Test 2

The bag with the collected moss with absorbed oil from test 1 was closed and placed in the same tank, but moored so that it did not touch any of the walls of the tank. The tank was washed prior to the test and the water was replaced with clean seawater. A tilting board was used to simulate gentle wave movement, and the bag was left for two weeks.

After the two weeks, the bag was still afloat, and no oil film could be observed in the tank. One litre of water was collected from the surface for analysis for oil hydrocarbons. No hydrocarbons were detected in the analysis and this shows that the moss retains the pollution in the pores for two weeks in water without any leakage.

1. Method to bring an absorption agent, in particular dried, hydrophobic and oleophilic peat moss, to oil spills at sea or on a lake from a plane, helicopter or ship so that the peat moss is spread out over the oil phase and absorbs and isolates the oil phase from the water phase so that it can be collected as a particulate mass, so that it can be treated further as a particulate mass with encapsulated oil in the pores, characterised in that the absorption agent (the peat moss) is compressed and enwrapped into a packaging that comprises a release mechanism which can release the peat moss from the packaging so that it is spread freely into or over the oil pollution, and the oil is then collected and processed further.

2. Method according to claim 1,
characterised in that the release mechanism comprises a blowing apart device and/or deformation device that can deform the packaging and release the peat moss.

3. Method according to claims 1-2, where the package is dropped from an air carrier such as an aeroplane/helicopter, characterised in that the release mechanism is triggered at an optional, predetermined height after being dropped and/or that the release mechanism is triggered on impact with the ocean surface.

4. Method according to claims 1-2, where the package is dropped from a ship, characterised in that and/or that the release mechanism is triggered by a control signal from a transmitter after the enwrapped peat moss is brought into a pollution with the help of a ship.

5. Method according to one of the preceding claims to bring dried, hydrophobic and oleophilic peat moss to an oil spill at sea or on a lake so that it is spread out over the oil phase and absorbs and isolates the oil phase from the water phase so that this can be gathered as a particulate mass, characterised in that an explosive charge and/or a deformation device for the packaging is an explosive and/or a compressed gas and/or a mechanical device and is set up to deform the packaging material and thus release the peat moss.

6. Method according to one of the preceding claims to gather absorbed oil pollution from an oil spill at sea or on a lake, where further processing takes place in that the peat moss, with the absorbed oil, is collected in a partially submersible trawl where the mesh opening does not allow any significant amounts of peat moss with the absorbed oil through, so that the pollution is collected in a dedicated trawl bag.

7. Method according to one of the preceding claims to gather absorbed oil pollution from an oil spill at sea or on a lake where oil booms, skimmers and/or pumps are used, characterised in that the peat moss with the absorbed oil is separated from water in a mechanical separator onboard a ship or on land, whereupon the water phase is continuously pumped out to the sea.

8. Method according to one of the preceding claims to temporary store the absorbed oil pollution from an oil spill at sea or on a lake, characterised in that the peat moss with the absorbed oil pollution is placed and isolated in bags and marked by marking buoys whereupon these are made to float in the sea or the water, whereupon these are towed ashore all together or in a substantial number, or brought onboard a ship for transport ashore all together or in a large number.

9. Method according to one of the preceding claims to neutralise the damage to the marine environment, birds or sea shore from oil spills at sea or on a lake when the weather conditions or other circumstances make collection impossible, characterised in that the addition is carried out without immediate collection/or for later collection.

10. Method according to one of the preceding claims for further processing of collected peat moss with absorbed oil, characterised in that a considerable part of the appended water is forced out of the mass without the bursting pressure for the pores in the peat moss with the absorbed oil being exceeded so that the pores burst and start to leak out, where the preferred applied pressure on the oil containing pores is below 4 bar.

11. Method according to one of the preceding claims for further treatment of the collected and dewatered peat moss with absorbed oil, characterised in that a considerable part of the absorbed oil is forced out of the peat moss in that the bursting pressure for the pores in the peat moss with absorbed oil is exceeded so that the pores burst and start, to leak where the preferred applied pressure on the oil containing pores is above 4 bar.

12. Application of pressed peat moss according to one of the preceding claims, characterised in that the peat moss with residual oil is used for energy purposes in that it is combusted.

13. Application of the method according to claims 1-9 for use in oil protection emergencies with oil spills at sea or on a lake.

14. Device for transport of an absorption agent, such as peat moss, to be spread over a spill of a pollutant, such as oil, for absorption of the same, characterised in that the absorption agent is compressed and stored in a packaging (a bag) that comprises a means for deformation of the packaging for subsequent release of the absorption agent from the packaging.

15. Device according to claim 14,
characterised in that the deformation agent is an explosive charge associated with the packaging, and set up to make the packaging burst open to release the absorption agent.

16. Application according to claim 14,
characterised in that means for remote control of a release mechanism associated with the deformation agent.
